(19) United States
(12) Patent Application Publication
(10) Pub. No.: US 2012/0319927 A1
(43) Pub. Date: Dec. 20, 2012

(54) REMOTE MANAGEMENT OF A SIMULTANEOUS DISPLAY OF MULTIMEDIA CONTENT IN DISPLAY DEVICES

(75) Inventor: IMTIYAZ ALTAFHUSSAIN KHATIB, Pune (IN)

(73) Assignee: NVIDIA Corporation, Santa Clara, CA (US)

(21) Appl. No.: 13/594,875

(22) Filed: Aug. 27, 2012

Related U.S. Application Data
(63) Continuation-in-part of application No. 12/326,109, filed on Dec. 2, 2008.

(51) Int. Cl. G09G 5/00

(52) U.S. Cl. 345/2.1

(57) ABSTRACT

A method includes simultaneously supporting a number of display devices coupled to a host computing device in a computer communication network through a multimedia processor provided on the host computing device. In addition, the method includes controlling a display attribute of one or more display device(s) of the number of display devices coupled to the host computing device from a remote computing device in the computer communication network to simultaneously control a multimedia content to be displayed on the one or more display device(s) of the number of display devices.

### CLAIM OF PRIORITY

This disclosure is a Continuation-in-Part patent application claiming priority on co-pending U.S. patent application Ser. No. 12/326,109 titled SIMPLIFYING CONFIGURATION OF MULTIPLE DISPLAY UNITS FOR COMMON USE, and filed on Dec. 2, 2008 having a common assignee and at least one common inventor.

### FIELD OF TECHNOLOGY

This disclosure relates generally to remote management of multimedia content using graphics processors and, more particularly, to a method, an apparatus, and a system of remote management of a simultaneous display of multimedia content in display units.

### BACKGROUND

Simultaneous display of multimedia content of a number of display devices connected to computing devices may require management software in each computing device to modify the configuration and display settings of the display devices, and to manage the multimedia content. The aforementioned management of the simultaneous display may require management of configuration, display settings, and multimedia content in each computing device. The installation of software in each computing device may be a tedious process, and a failure of the display devices whose contents are displayed simultaneously may add to the difficulty in management of the display process.

### SUMMARY

Disclosed are a method, an apparatus, and a system of remote management of simultaneous display of multimedia content in display units.

In one aspect, a method includes simultaneously supporting a number of display devices coupled to a host computing device in a computer communication network through a multimedia processor provided on a host computing device. In addition, the method includes controlling a display attribute of one or more display device(s) of the number of display devices coupled to the host computing device from a remote computing device in the computer communication network to simultaneously control a multimedia content to be displayed on the one or more display device(s) of the number of display devices.

In another aspect, a method includes communicatively coupling a remote computing device to a host computing device through a computer communication network, coupling a number of display devices to the host computing device, and providing a user interface from the remote computing device to the host computing device through the computer communication network. In addition, the method includes configuring a multimedia processor of the host computing device through the user interface to enable each display device of the number of display devices to be regarded as a unified virtual display. The method further includes accessing, configuring, and/or controlling a display attribute of one or more display device(s) of the number of display devices, coupled to the host computing device, and regarded as the unified virtual display, through the user interface from the remote computing device.

In yet another aspect, a system includes a host computing device comprising a multimedia processor to simultaneously support a number of display devices, and a remote computing device to control a display attribute of one or more display devices of the number of display devices coupled to the host computing device through a computer communication network. A multimedia content to be displayed on the one or more display device(s) of the number of display devices is simultaneously controlled through the control of the display attribute of the one or more display device(s) of the number of display devices coupled to the host computing device.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a process flow detailing the operations involved in remote management of display devices, according to one or more embodiments.

FIG. 2 is a schematic view illustrating remote management of the number of display devices, according to one or more embodiments.

FIG. 3 is a system view illustrating remote management of display devices, according to one or more embodiments.

FIG. 4 is a Graphical User Interface (GUI) view providing a preview of a multimedia content at a remote computing device, according to one or more embodiments.

FIG. 5 is a GUI view illustrating a remote edge overlap management, according to one or more embodiments.

FIG. 6 is an illustrative view of possible configurations of the display projectors during remote management, according to one or more embodiments.

FIG. 7 is a GUI illustration of an alerting scheme, according to one or more embodiments.

FIG. 8 is a process flow detailing the operations involved in a remote management of display devices through a user interface, according to one or more embodiments.

Other features of the present embodiments will be apparent from the accompanying drawings and from the detailed description that follows.

### DETAILED DESCRIPTION

Example embodiments, as described below, may be used to provide a method, a system, and an apparatus of remote management of simultaneous display of multimedia content in display units. Although the present embodiments have been described with reference to specific example embodiments, it will be evident that various modifications and changes may be made to these embodiments without departing from the broader spirit and scope of the various embodiments.

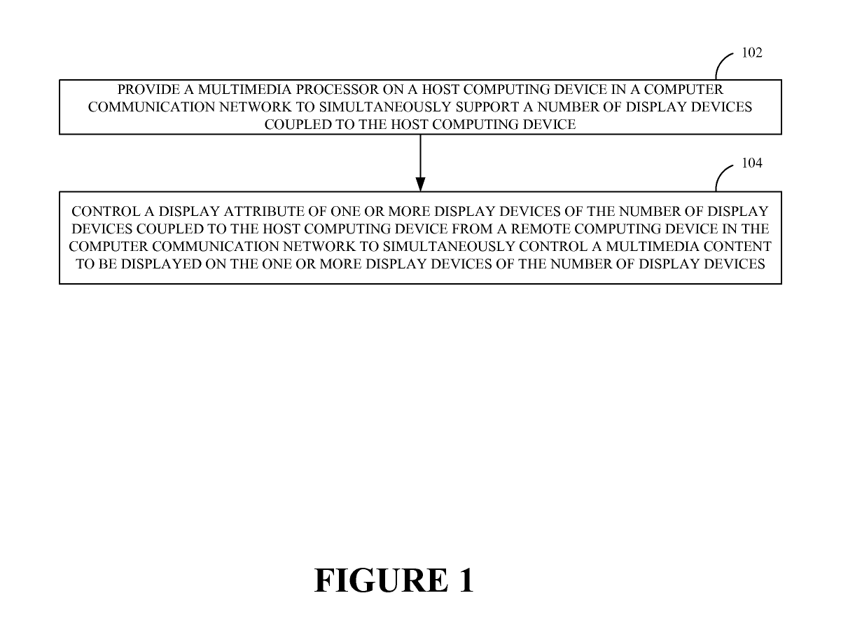

FIG. 1 is a process flow detailing the operations involved in a remote management of display devices, according to one or more embodiments. In operation 102, a number of display devices 210_{1-N} coupled to a host computing device 202 in a computer communication network 204 (e.g., Internet) may be simultaneously supported using a multimedia processor 212 provided on the host computing device 202. In one or more embodiments, a number of processors may be interfaced, coupled, and/or configured as the multimedia processor 212 in the host computing device 202. For example, the number of processors may be configured with a Scalable Link Interface (SLI™). In one or more embodiments, the number of processors described herein may be Graphics Processing Units (GPUs). In one or more embodiments, the number of processors interfaced, coupled and/or configured as the multimedia processor 212 may support the number of display devices 210_{1-N} in the host computing device 202.

In operation 104, a display attribute of one or more display devices of the number of display devices 210_{1-N} coupled to the host computing device 202 may be controlled from the remote computing device 208 in the computer communication network 204 to simultaneously control a multimedia content (e.g., video, animation, graphics, multimedia presentation) to be displayed on one or more display devices of the number of display devices coupled to the host computing device 202. In one or more embodiments, the display attribute of one or more display devices of the number of display devices 210_{1-N} coupled to the host computing device 202 may be accessed, configured, and/or controlled from the remote computing device 208 through a user interface 206. In one or more embodiments, the display attribute of one or more display devices of the number of display devices may be a resolution, a color, a display data, a refresh rate, a flicker, a color quality, and/or a digital vibrance.

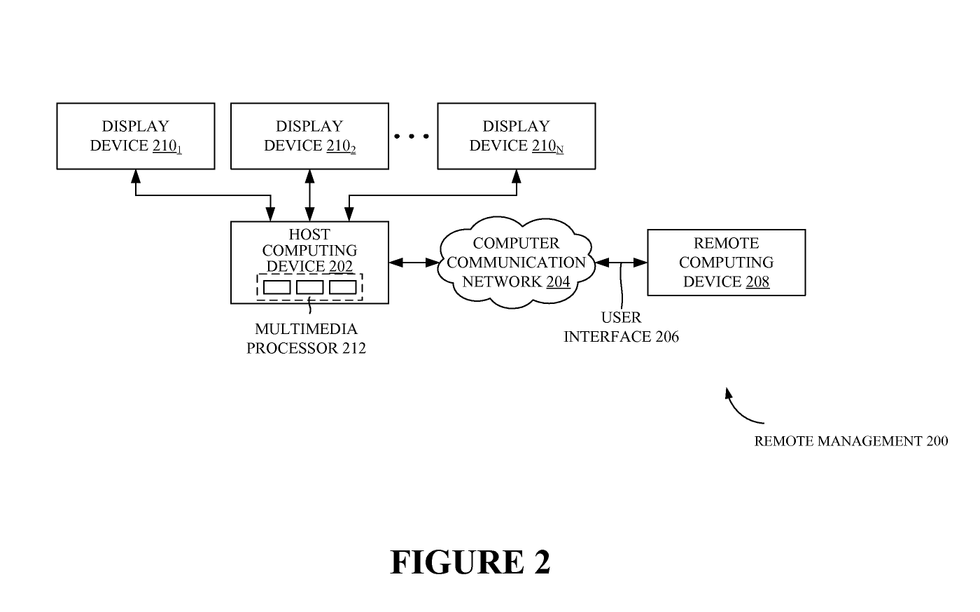

FIG. 2 is a schematic view illustrating remote management 200 of the number of display devices, according to one or more embodiments. In one or more embodiments, the number of display devices 210_{1-N} may be coupled to the host computing device 202. In one or more embodiments, a number of processors may be communicatively coupled to function as the multimedia processor 212. In one or more embodiments, the multimedia processor 212 in the host computing device 202 may enable support of the number of display devices 210_{1-N} communicatively coupled to the host computing device 202. In one or more embodiments, the number of processors may be GPUs. In one or more embodiments, the number of display devices 210_{1-N} discussed herein may include, but are not limited to, computer monitors, Low Voltage Differential Signaling (LVDS) displays, projectors, and Liquid Crystal Display (LCD) panels.

In one or more embodiments, the remote computing device 208 may control the display attribute of one or more display devices of the number of display devices 210_{1-N} coupled to the host computing device 202 via the user interface 206 provided through the computer communication network 204 (e.g., Internet). In one or more embodiments, the user interface 206 may be a remote management software. In one or more embodiments, the display attribute of one or more display devices of the multiple display devices 210_{1-N} may be accessed, configured, and/or controlled through the user interface 206. In one or more embodiments, multimedia content to be displayed on one or more display devices of the number of display devices 210_{1-N} may simultaneously be controlled through the user interface 206. In one or more embodiments, the remote computing device 208 may be a computer, a laptop or a workstation.

In one or more embodiments, the remote computing device 208 may be in the vicinity of the host computing device 202 or in a remote location. In one or more embodiments, the remote management software may be installed both in the host computing device 202 and the remote computing device 208. In one or more embodiments, the remote management software resident on the remote computing device 208 may provide the user interface 206 to control the display attribute of one or more display devices of the number of display devices 210_{1-N} from the remote computing device 208. In one or more embodiments, the user interface 206 may be provided with a graphical user interface (GUI) at the remote computing device 208.

In one or more embodiments, a number of coupled processors in the host computing device 202 may be configured to function as the multimedia processor 212 through the user interface 206 from the remote computing device 208 prior to the accessing, configuring, and/or controlling of the display attribute. In one or more embodiments, a capability of sharing the display workload associated with simultaneously rendering a multimedia content on one or more display devices of the number of display devices 210_{1-N} may be provided to the number of coupled processors due to the aforementioned configuration of the number of coupled processors to function as the multimedia processor 212. In one or more embodiments, the number of display devices may be coupled to the host computing device 202 through a Digital Video Interface (DVI) or a High Definition Multimedia Interface (HDMI).

In one or more embodiments, an identification data associated with each of the number of display devices 210_{1-N} coupled to the host computing device 202 may be communicated to the remote computing device 208 through the user interface 206. In one or more embodiments, the identification data of the number of display devices 210_{1-N} may be an Extended Display Identification Data (EDID). In one or more embodiments, the capability to access, configure, and/or control the display attribute of each of the number of display devices 210_{1-N} from the remote computing device 208 may be acquired following the successful communication of the identification data of each of the number of display devices 210_{1-N} to the remote computing device 208. In one or more embodiments, the identification data may be communicated to a driver of the multimedia processor 212 prior to the remote computing device 208 through the user interface 206.

In one or more embodiments, the multimedia content may be rendered (i.e. displayed) simultaneously on one or more display devices of the number of display devices 210_{1-N}. In one or more embodiments, the multimedia content may be rendered in a clone mode, an independent mode, and/or an extended mode. In one or more embodiments, in the clone code, a same multimedia content may be rendered on each display device of an M number of display devices, where M is a positive integer. Considering N as the total number of the display devices, 2≦M≦N. In one or more embodiments, in the independent mode, a unique multimedia content may be rendered on each display device of a K number of display devices, where K is a positive integer and 2≦K≦N. In one or more embodiments, in the extended mode, a multimedia content may be rendered extended across an L number of display devices, where L is a positive integer and 2≦L≦N.

In one embodiment, the user interface 206 may enable the remote computing device 208 to treat all of the number of display devices 210_{1-N} as a single display in the extended mode.

In one or more embodiments, the 208, the user interface 206 may provide a capability to preview the multimedia content at the remote computing device 208 through the GUI. In addition, in one or more embodiments, the user interface 206 may provide a capability to manage an edge overlapping of multimedia content between display devices during the previewing of multimedia content through the GUI. Furthermore, in one or more embodiments, the user interface 206 may also provide a capability to modify an arrangement of the display devices during the preview of the multimedia content associated with the display devices.

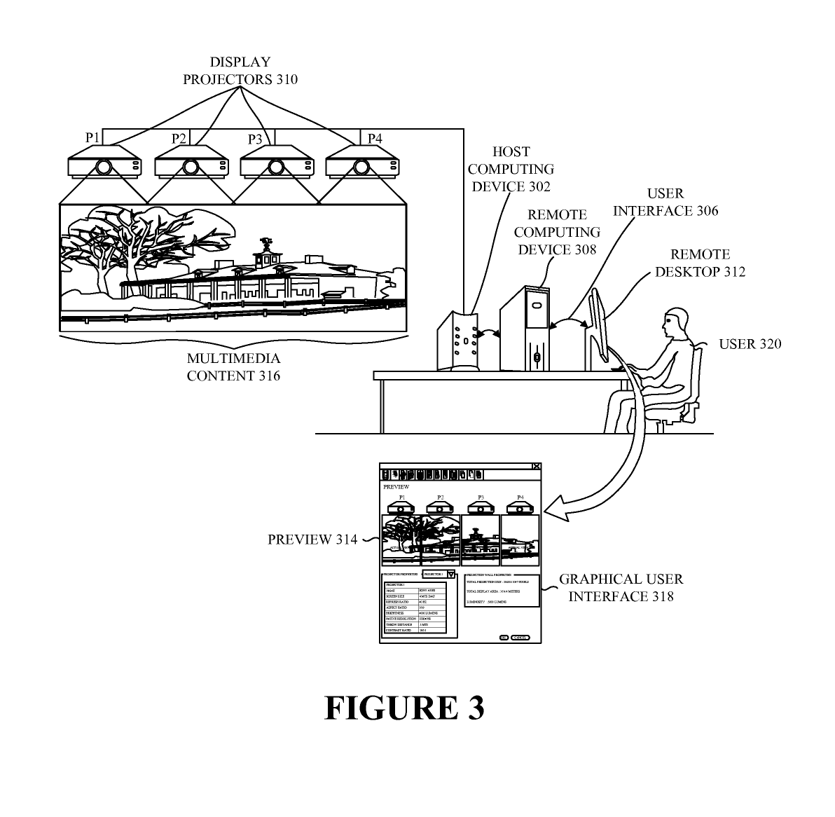

FIG. 3 is system view illustrating remote management of display devices, according to one or more embodiments. In particular, FIG. 3 illustrates a host computing device 302, a remote computing device 308, a user interface 306, display projectors 310, a remote desktop 312, a preview 314, a multimedia content 316, a GUI 318 and a user 320, according to one or more embodiments. The host computing device 302, the remote computing device 308, the multimedia content 316, the user interface 306, and the GUI 318 may all correspond to the host computing device 202, the remote computing device 208, the multimedia content, the user interface 206, and the GUI, as discussed with regard to FIG. 2. The display projectors 310 serve as examples of the number of display devices 210_{1-N}.

As described in FIG. 3, the user interface 306 may be provided to the user 320 at the remote computing device 308 to control the display attributes of the display projectors 310 to simultaneously control the multimedia content 316 being displayed in the display projectors 310. In one or more embodiments, the display attributes of the display projectors 310 may be accessed, configured, and/or controlled through the GUI 318 provided at the remote computing device 308 through the remote desktop 312 of the remote computing device 308.

In one or more embodiments, the multimedia content 316 to be displayed on the display projectors 310 may be modified at the remote desktop 312 of the remote computing device 308. For example, the modifications may include a change of display attributes such as a resolution, a color, a display data, a refresh rate, a flicker, a color quality, and/or a digital vibrance of the multimedia content 316 to be displayed on the display projectors 310. In one or more embodiments, the preview 314 of the multimedia content 316 may be provided through the GUI 318 at the remote desktop 312. In one or more embodiments, this may enable a modification of the multimedia content 316 of any number of display devices previewed through the GUI 318. In one or more embodiments, the modified multimedia content may be previewed as a whole, including all of the multimedia content 316 of a chosen number of display projectors 310, through the GUI 318. In one or more embodiments, the user 320 may approve/disapprove the modification of the multimedia content 316 to be displayed on the display projectors 310.

In one or more embodiments, an addition of a new display projector to the display projectors 310 may be indicated to the remote computing device 308 through the user interface 306. In one or more embodiments, the indication may be in the form of a thumbnail image of a display projector being added to the existing thumbnail images of the display projectors 310 as shown in FIG. 3. In addition, in one embodiment, the information associated with the newly added display projector may be provided along with the indication. In one embodiment, the indication may be in the form of a popup window.

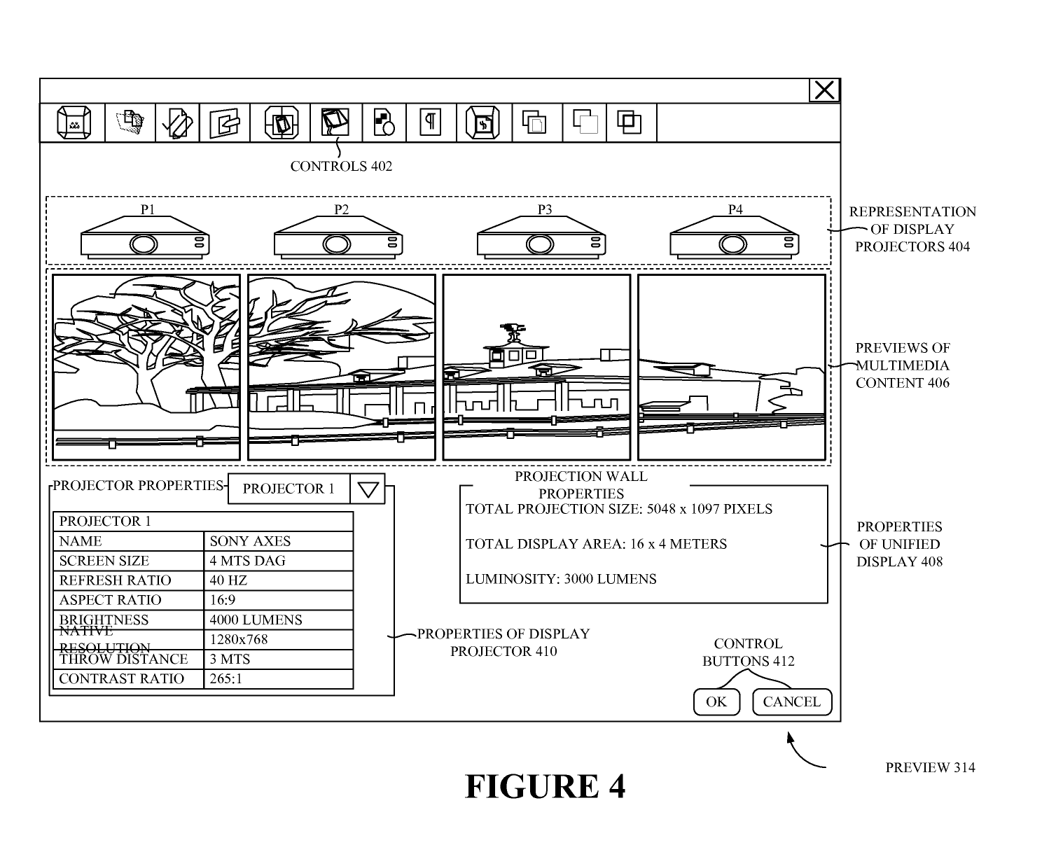

FIG. 4 is a GUI view providing a preview 314 of a multimedia content at the remote computing device 308, according to one or more embodiments. In one or more embodiments, the preview 314 may include graphical representations (e.g., thumbnail images) of the display projectors 310 (shown as Representation of Display Projectors 404 in FIG. 4). In one or more embodiments, the display properties associated with each of the display projectors 310 (shown as Properties of Display Projector 410 in FIG. 4), and the properties associated with a unified display including all of the display projectors 310 (shown as Properties of Unified Display 408 in FIG. 4) may also be shown in the preview 314. In one or more embodiments, the display properties associated with a display projector 310 may be shown during user selection of the display projector 310.

In one or more embodiments, the display properties associated with the projector 310 may include one or more of a product name, screen size, refresh ratio, aspect ratio, brightness, native resolution, throw distance, and a contrast ratio, as shown in FIG. 4. In one or more embodiments, the properties associated with the unified display may include one or more of a total projection size, a total display area, and a luminosity, as shown in FIG. 4. In one or more embodiments, controls 402 may be provided to enable control of the display attributes and/or the previews of the multimedia content 406 associated with the display projectors 310.

FIG. 4 shows the remote previews of multimedia content 406 associated with the display projectors 310 in an extended mode. In one or more embodiments, the previews of modifications made to multimedia content to be displayed on each of the display projectors 310 may be provided in the GUI 318. In one or more embodiments, the modifications may be confirmed/cancelled using the control buttons 412 provided in the GUI 318. In one or more embodiments, the modified multimedia content may be displayed in the display projectors 310 following the confirmation using the control buttons 412. Alternately, unmodified multimedia content may be displayed in the display projectors 310 following the cancellation using the control buttons 412.

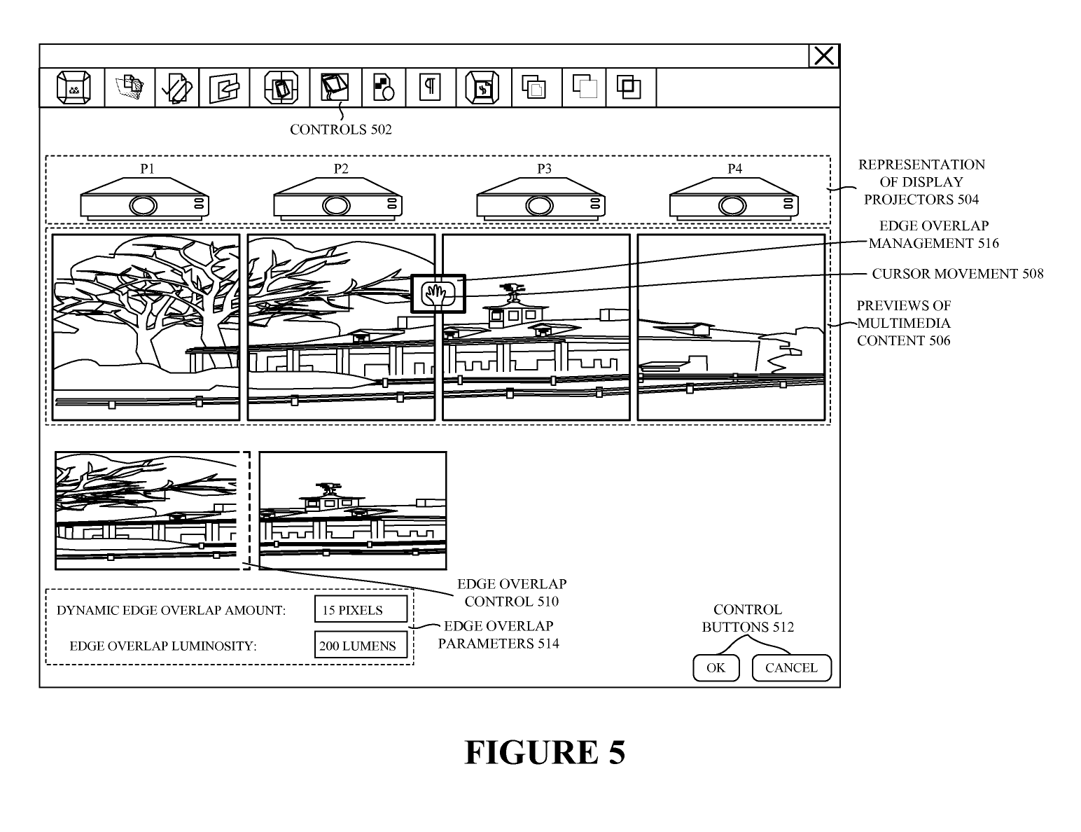

FIG. 5 is a GUI view illustrating a remote edge overlap management, according to one or more embodiments. The controls 502, Representation of Display Projectors 504, Previews of Multimedia Content 506, control buttons 512, and Representation of Display Projectors 504 all are equivalent to counterparts thereof in FIG. 4.

In one or more embodiments, edge overlap management 516 may be performed using the cursor movement 506. In one or more embodiments, the cursor movement 506 may first be used to select the requisite display projectors 310. In one or more embodiments, the delimiters between multimedia content previews associated with adjacent display projectors 310 may be extended (i.e., dragged) using the cursor movement 506, as shown as the edge overlap control 510 in FIG. 5. In one or more embodiments, parameters associated with the delimiters may also be changed. In one or more embodiments, the edge overlap parameters 514 of the multimedia content associated with adjacent display projectors 310 may be displayed in the GUI 318 upon selection of the appropriate display projectors 310 using the cursor movement 508. In one or more embodiments, the edge overlap parameters 514 may include a dynamic edge overlap amount (in pixels) and/or an edge overlap luminosity. In one or more embodiments, the edge overlap parameters 514 may be modified in an input box provided in the GUI 318. In one or more embodiments, the edge overlap control 510 may result in a modified preview, as shown in FIG. 5. The control buttons 512 may enable application/cancellation of the edge overlap modification in the display projectors 310. In one or more embodiments, the edge overlap management may be performed from the remote computing device 308.

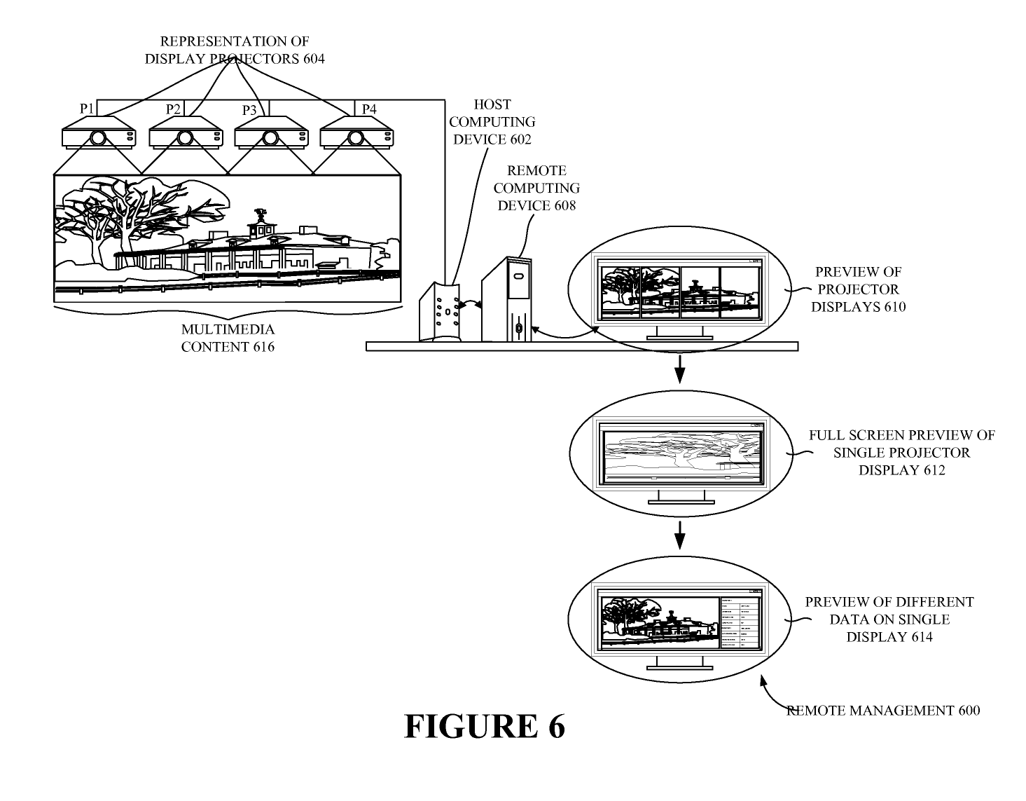

FIG. 6 illustrates possible configurations of the display projectors 310 during remote management 600, according to one or more embodiments. In FIG. 6, the Representation of Display Projectors 604 is shown as thumbnail images of the display projectors 310. As mentioned in the previous figures, the multimedia content 616 (similar to multimedia content 316) to be displayed in the display projectors 310 may be modified at the remote computing device 608 (similar to the remote computing device 308). In one or more embodiments, the display projectors 310 coupled to the host computing device 602 (similar to the host computing device 302) may be configured to display the multimedia content 616 based on configurations defined at the remote computing device 608.

In one or more embodiments, the user interface 206 may provide various configurations in which the multimedia content 616 may be previewed and presented on the display projectors 310. In one or more embodiments, the configurations may define one or more of display layouts, display attributes, and display area. In one or more embodiments, a spatial location of the display projectors 310 may be logically arranged in a unified display preview that includes multimedia content of each display projector 310 prior to multimedia content management and/or display in the display projectors 310. In one or more embodiments, the multimedia content 616 to be displayed in each of the display projectors 310 may be previewed in a unified manner at the remote computing device 608, as shown in the Preview of Projector Displays 610 in FIG. 6. In one or more embodiments, the multimedia content 616 of each of the display projectors 310 may be independently previewed on a full screen at the remote computing device 608, as shown in the Full Screen Preview of Single Projector Display 612 in FIG. 6. In one or more embodiments, multiple multimedia contents may be previewed on a screen at the remote computing device 608. As shown in Preview of Different Data on Single Display 614 in FIG. 6, a multimedia content may be added to the preview of the display projectors 310 at the remote computing device 608.

The abovementioned configurations merely serve as examples, and do not serve to limit the exemplary embodiments. Other possible configurations are well within the scope of the exemplary embodiments.

In one or more embodiments, the display projectors 310 may be arranged in a P X Q matrix, P being the number of display projectors 310 in a row and Q being the number of display projectors 310 in a column (e.g., 1 X 2, 2 X 4, 1 X 4, 1 X 8).

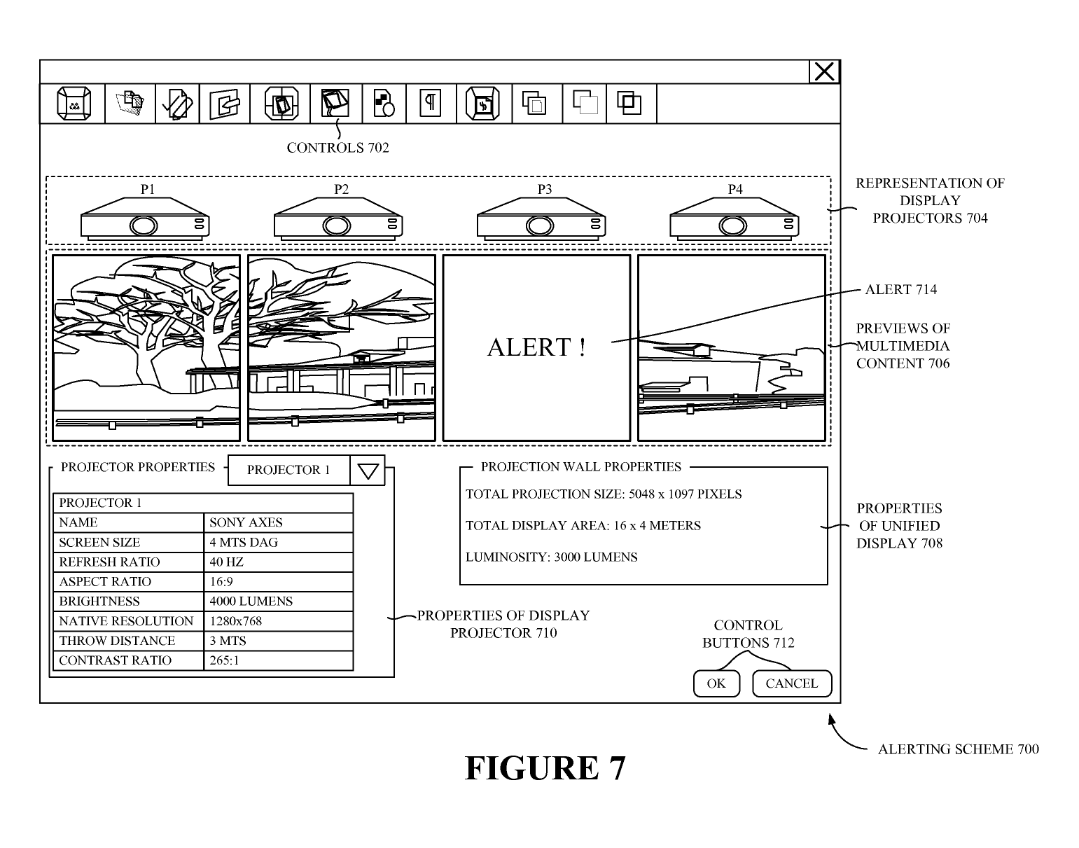

FIG. 7 is a GUI illustration of an alerting scheme 700, according to one or more embodiments. The controls 702, Representation of Display Projectors 704, Previews of Multimedia Content 706, control buttons 712, Properties of Unified Display 708, and Properties of Display Projector 710 all are equivalent to counterparts thereof in FIG. 4.

In one or more embodiments, a malfunctioning and/or a blanking of a display projector 310 may be alerted to the user 320 at the remote computing device 608, as shown in the Alert 714 of FIG. 4. Other possible alerting schemes are well within the scope of the exemplary embodiments.

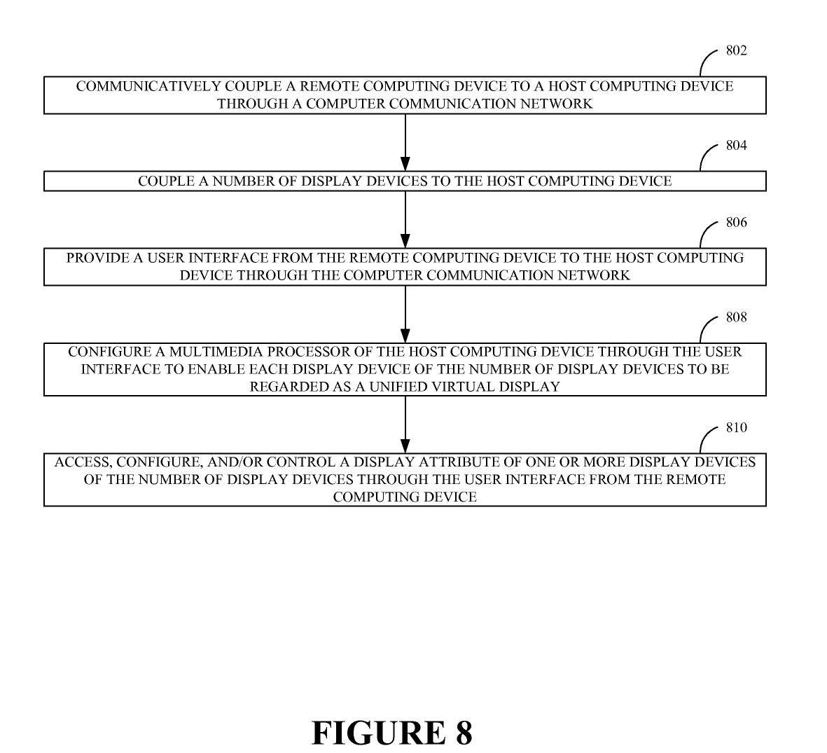

FIG. 8 is a process flow detailing the operations involved in the remote management of the number of display devices 210_{1-N} through a user interface 206, according to one or more embodiments. In operation 802, the remote computing device 208 may be communicatively coupled to the host computing device 202 through the computer communication network 204. In operation 804, the number of display devices 210_{1-N} may be coupled to the host computing device 202. In operation 806, the user interface 206 may be provided from the remote computing device 208 to the host computing device 202 through the computer communication network 204. In operation 808, the multimedia processor 212 of the host computing device 202 may be configured through the user interface 206 to enable each display device of the number of display devices 210_{1-N} to be regarded as a unified virtual display. In operation 810, the display attribute of one or more of a display device of the number of display devices 210_{1-N} may be accessed, configured and/or controlled through the user interface 206 from the remote computing device.

In one or more embodiments, the remote management of display devices may find utility in entertainment events, oil and gas exploration, manufacturing environments, and/or seismic analysis. In one or more embodiments, the remote management may enable a user to host different content on each display device, and yet treat the unified set of display devices seamlessly as a whole.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Accordingly, the specification and drawings are to be regarded in an illustrative rather than a restrictive sense.

What is claimed is:

1. A method comprising:
simultaneously supporting a plurality of display devices coupled to a host computing device in a computer communication network through a multimedia processor provided on the host computing device; and
controlling a display attribute of at least one display device of the plurality of display devices coupled to the host computing device from a remote computing device in the computer communication network to simultaneously control a multimedia content to be displayed on the at least one display device of the plurality of display devices.

2. The method of claim 1, further comprising:
providing a user interface to the host computing device from the remote computing device through the computer communication network; and
at least one of accessing, configuring, and controlling the display attribute of the at least one display device of the plurality of display devices through the user interface from the remote computing device.

3. The method of claim 1, comprising controlling at least one of a resolution, a color, a display data, a refresh rate, a flicker, a color quality, and a digital vibrance of the at least one display device of the plurality of display devices.

4. The method of claim 1, comprising providing a plurality of Low Voltage Differential Signaling (LVDS) displays, projectors, and Liquid Crystal Display (LCD) panels as the plurality of display devices.

5. The method of claim 2, further comprising:
providing a plurality of coupled processors as the multimedia processor in the host computing device; and
configuring the plurality of coupled processors through the user interface to share a display workload associated with simultaneously rendering a multimedia content on at least one display device of the plurality of display devices.

6. The method of claim 5, further comprising configuring the plurality of display devices in the host computing device through the user interface to display a multimedia content in at least one of a clone mode, an independent mode and an extended mode,
wherein the clone mode includes displaying a same multimedia content on each display device of M display devices,
wherein the independent mode includes displaying a unique multimedia content on each display device of K display devices,
wherein the extended mode includes displaying a multimedia content extended across L display devices, and
wherein 2≦M≦N, 2≦K≦N, 2≦L≦N, N being a total number of the plurality of display devices.

7. The method of claim 6, further comprising previewing the multimedia content of at least one of M, K, and L display devices of the host computing device and a single display device of the plurality of display devices of the host computing device on a display device of the remote computing device.

8. The method of claim 7, further comprising managing an edge overlapping of multimedia content between display devices of the plurality of display devices previewed on the display device of the remote computing device.

9. The method of claim 7, further comprising displaying an alert on the display device of the remote computing device to indicate one of a malfunctioning and a blanking of a display device of the plurality of display devices of the host computing device.

10. The method of claim 7, further comprising modifying an arrangement of the plurality of display devices in the preview.

11. The method of claim 7, further comprising :
modifying a multimedia content of at least one display device of the plurality of display devices of the host computing device previewed on the display device of the remote computing device; and
previewing, on the display device of the remote computing device, the modified multimedia content as part of a multimedia content of the plurality of display devices on the host computing device.

12. A method comprising:
communicatively coupling a remote computing device to a host computing device through a computer communication network;
coupling a plurality of display devices to the host computing device;
providing a user interface from the remote computing device to the host computing device through the computer communication network;
configuring a multimedia processor of the host computing device through the user interface to enable each display device of the plurality of display devices to be regarded as a unified virtual display; and
at least one of accessing, configuring, and controlling a display attribute of at least one display device of the plurality of display devices, coupled to the host computing device, and regarded as the unified virtual display, through the user interface from the remote computing device.

13. The method of claim 12, further comprising communicating an identification data of each display device of the plurality of display devices coupled to the host computing device to the remote computing device through the user interface.

14. The method of claim 12, further comprising indicating coupling of a new display device to the host computing device to the remote computing device through the user interface.

15. The method of claim 12, wherein the display attribute includes at least one of a resolution, a color, a display data, a refresh rate, a flicker, a color quality, and a digital vibrance.

16. The method of claim 12, further comprising logically arranging a spatial location of the plurality of display devices in the unified virtual display comprising a multimedia content of each display device of the plurality of display devices.

17. The method of claim 13, further comprising communicating the identification data to a driver of the multimedia processor of the host computing device prior to communicating the identification data to the remote computing device through the user interface.

18. A system comprising:
a host computing device comprising a multimedia processor to simultaneously support a plurality of display devices; and
a remote computing device to control a display attribute of at least one display device of the plurality of display devices coupled to the host computing device through a computer communication network, a multimedia content to be displayed on the at least one display device of the plurality of display devices being simultaneously controlled through the control of the display attribute of the at least one display device of the plurality of display devices coupled to the host computing device.

19. The system of claim 18, further comprising a user interface to the host computing device from the remote computing device through the computer communication network to provide a capability to at least one of access, configure, and control the display attribute of the at least one display device of the plurality of display devices.

20. The system of claim 18, wherein the display attribute includes at least one of a resolution, a color, a display data, a refresh rate, a flicker, a color quality, and a digital vibrance.
